(19) United States
(12) Patent Application Publication
(10) Pub. No.: US 2022/0245829 A1
(43) Pub. Date: Aug. 4, 2022

(54) MOVEMENT STATUS LEARNING APPARATUS, MOVEMENT STATUS RECOGNITION APPARATUS, MODEL LEARNING METHOD, MOVEMENT STATUS RECOGNITION METHOD AND PROGRAM

(71) Applicant: NIPPON TELEGRAPH AND TELEPHONE CORPORATION, Tokyo (JP)

(72) Inventors: Shuhei YAMAMOTO, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/614,190

(22) PCT Filed: May 27, 2019
(86) PCT No.: PCT/JP2019/020952

§ 371 Date: Nov. 24, 2021

(51) Int. Cl. G06T 7/246; G06V 10/40; G06V 20/50; G06V 10/82

(52) U.S. Cl. CPC G06T 7/246; G06V 10/40; G06T 2207/20081; G06V 10/82; G06V 20/50

(57) ABSTRACT

A movement status learning device is provided with a detection unit that detects a plurality of objects from image data of each frame generated from video data, a calculation unit that calculates a feature amount of each object detected by the detection unit, a selection unit that sorts the plurality of objects on a basis of the feature amount calculated by the calculation unit, and a learning unit that learns a model on a basis of video data, sensor data, a feature amount of the plurality of objects in the sorted order, and annotation data.

### TECHNICAL FIELD

The present invention relates to technology for achieving precise automatic recognition of the movement status of a user from video and sensor data acquired by the user.

### BACKGROUND ART

As imaging devices are miniaturized further and devices such as GPS and gyro sensors use less power, it has become possible to record the movements of a user easily as a variety of data, such as video, position information, and accelerations. The detailed analysis of the movements of the user from this data is useful for a variety of applications.

For example, if data such as video from a first-person viewpoint acquired through eyewear or the like and acceleration data acquired by a wearable sensor could be used to automatically recognize and analyze a status, such as a status of window shopping or a status of crossing the street at a crosswalk, it would be useful for various purposes such as personalizing services.

In the related art, a technology that estimates a transportation mode of a user from GPS position information and speed information exists as a technology of automatically recognizing the movement status of a user from sensor information (see Non-Patent Literature 1). In addition, a technology that uses information such as acceleration acquired from a smartphone to analyze activities such as walking, jogging, and ascending or descending stairs also exists (see Non-Patent Literature 2).

### CITATION LIST

### Patent Literature

Patent Literature 1: Japanese Patent Laid-Open No. 2018-041319
Patent Literature 2: Japanese Patent Laid-Open No. 2018-198028

### Non-Patent Literature

Non-Patent Literature 1: Zheng, Y., Liu, L., Wang, L., and Xie, X.: Learning transportation mode from raw GPS data for geographic applications on the web. In Proc. of World Wide Web 2008, pp. 247-256, 2008.
Non-Patent Literature 2: Jennifer R. Kwapisz, Gary M. Weiss, Samuel A. Moore: Activity Recognition using Cell Phone Accelerometers, Proc. of SensorKDD 2010.

### SUMMARY OF THE INVENTION

### Technical Problem

However, the above methods of the related art only use sensor information, and therefore are incapable of recognizing the movement status of a user while accounting for video information. For example, in the case of attempting to grasp the movement status of a user from wearable sensor data, even if it is understood that the user is walking, it is difficult to automatically recognize from sensor data alone a detailed status of the user, such as a status of window shopping or a status of crossing the street at a crosswalk.

On the other hand, even if video data and sensor data inputs are combined to use a simple classification model such as a support vector machine (SVM), which is a machine learning technology, precise movement status recognition is difficult because the video data and the sensor data have different degrees of information abstraction. Furthermore, there is also a problem in that if fine features in the video (for example, the positional relationship between a pedestrian or signal and oneself) are not ascertained, a wider variety of movement statuses cannot be recognized.

The present invention has been devised in light of the above points, and an object is to provide a technology making it possible to recognize the movement status of a user precisely on the basis of video data and sensor data information.

### Means for Solving the Problem

According to the disclosed technology, there is provided a movement status learning device including:

a detection unit that detects a plurality of objects from image data of each frame generated from video data;

a calculation unit that calculates a feature amount of each object detected by the detection unit;

a selection unit that sorts the plurality of objects on a basis of the feature amount calculated by the calculation unit; and

a learning unit that learns a model on a basis of video data, sensor data, a feature amount of the plurality of objects in the sorted order, and annotation data.

### Effects of the Invention

According to the disclosed technology, there is provided a technology making it possible to recognize the movement status of a user precisely on the basis of video data and sensor data information.

### BRIEF DESCRIPTION OF DRAWINGS

FIG. 1 is a configuration diagram of a movement status recognition device according to an embodiment of the present invention.

FIG. 2 is a configuration diagram of the movement status recognition device according to an embodiment of the present invention.

FIG. 3 is a hardware configuration diagram of the movement status recognition device.

FIG. 4 is a flowchart illustrating a process by the movement status recognition device.

FIG. 5 is a flowchart illustrating a process by the movement status recognition device.

FIG. 6 is a diagram illustrating an example of the storage format of a video data DB.

FIG. 7 is a diagram illustrating an example of the storage format of a sensor data DB.

FIG. 8 is a diagram illustrating an example of the storage format of an annotation DB.

FIG. 9 is a flowchart illustrating a process by a video data preprocessing unit.

FIG. 10 is a diagram illustrating an example of image data for each frame generated from video data by the video data preprocessing unit.

FIG. 11 is a flowchart illustrating a process by a sensor data preprocessing unit.

FIG. 12 is a flowchart illustrating a process by an object-in-image detection unit.

FIG. 13 is a diagram illustrating an example of object detection results obtained from image data by the object-in-image detection unit.

FIG. 14 is a flowchart illustrating a process by an object feature calculation unit.

FIG. 15 is a diagram illustrating an example of feature vector data of an object for each frame generated from object detection results by the object feature calculation unit.

FIG. 16 is a diagram illustrating an example of variables referenced when the object feature calculation unit calculates feature amounts with respect to object detection results.

FIG. 17 is a flowchart illustrating a process by an important object selection unit.

FIG. 18 is a diagram illustrating an example of the structure of a DNN constructed by a movement status recognition DNN model construction unit.

FIG. 19 is a diagram illustrating an example of the structure of an object encoder DNN constructed by the movement status recognition DNN model construction unit.

FIG. 20 is a flowchart illustrating a process by a movement status recognition DNN model learning unit.

FIG. 21 is a diagram illustrating an example of the storage format of a movement status recognition DNN model DB.

FIG. 22 is a flowchart illustrating a process by a movement status recognition unit.

### DESCRIPTION OF EMBODIMENTS

Hereinafter, exemplary embodiments of the present invention will be described with reference to the drawings. The embodiments described hereinafter are merely examples, and an embodiment applying the present invention is not limited to the following embodiments.

(Exemplary Device Configuration)

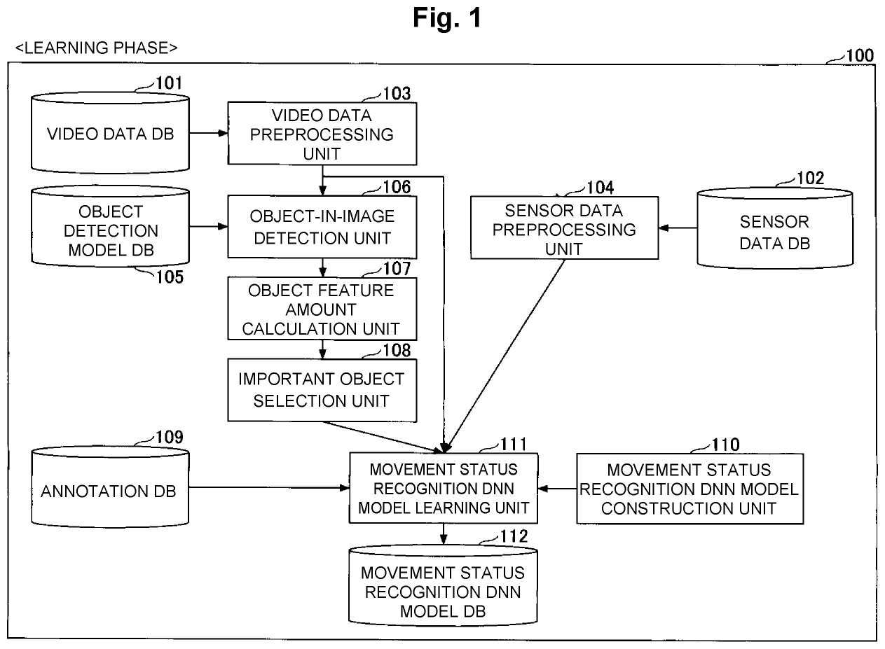

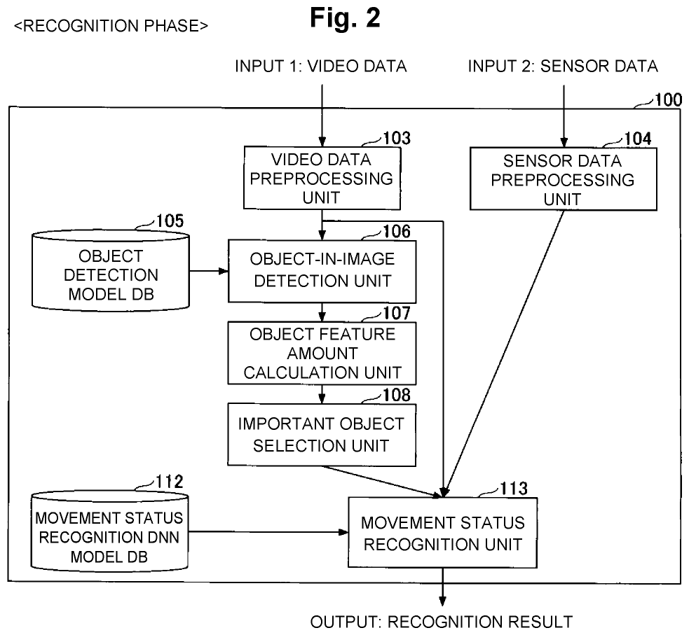

FIGS. 1 and 2 illustrate a configuration of a movement status recognition device 100 according to an embodiment of the present invention. FIG. 1 illustrates the configuration in a learning phase, while FIG. 2 illustrates the configuration in a prediction phase.

<Configuration in Learning Phase>

As illustrated in FIG. 1, in the learning phase, the movement status recognition device 100 includes a video database (DB) 101, a sensor data DB 102, a video data preprocessing unit 103, a sensor data preprocessing unit 104, an object detection model DB 105, an object-in-image detection unit 106, an object feature amount calculation unit 107, an important object selection unit 108, an annotation DB 109, a movement status recognition DNN model construction unit 110, a movement status recognition DNN model learning unit 111, and a movement status recognition DNN model DB 112. Note that the object-in-image detection unit 106, the object feature amount calculation unit 107, the important object selection unit 108, and the movement status recognition DNN model learning unit 111 may also be referred to as the detection unit, the calculation unit, the selection unit, and the learning unit, respectively.

The movement status recognition device 100 creates a movement status recognition DNN model using information from each DB. Here, the video database DB 101 and the sensor data DB 102 are assumed to be constructed in advance such that related video data and sensor data are associated by a data ID.

For the process of constructing the video database DB 101 and the sensor data DB 102, pairs of video data and sensor data may be input by a system operator for example, an ID that uniquely identifies each pair may be assigned to the input video data and sensor data as a data ID, and the data may be stored in the video database DB 101 and the sensor data DB 102, respectively.

A model structure and parameters of a trained object detection model are stored in the object detection model DB 105. Here, object detection refers to detecting a general name of an object appearing in a single image, together with a boundary region (bounding box) where the object appears. For the object detection model herein, it is possible to use a known model such as an SVM trained with image feature amounts like in HOG (Dalal, Navneet and Triggs, Bill: Histograms of Oriented Gradients for Human Detection. In Proc. of Computer Vision and Pattern Recognition 2005, pp. 886-893, 2005) or a DNN like in YOLO (J. Redmon, S. Divvala, R. Girshick and A. Farhadi: You Only Look Once: Unified, Real-Time Object Detection, Proc. of Computer Vision and Pattern Recognition 2016, pp. 779-788, 2016).

Also, an annotation name for each data ID is stored in the annotation DB 104. Here, an annotation is assumed to be a description of the status in a video from a first-person viewpoint acquired by eyewear for example, and corresponds to window shopping, crossing the street at a crosswalk, or the like. In the process of constructing the annotation DB 104, like the process of constructing the video database DB 101 and the sensor data DB 102, an annotation for each ID may be input by a system operator for example, and the input result may be stored in a DB.

<Configuration in Recognition Phase>

As illustrated in FIG. 2, in the recognition phase, the movement status recognition device 100 includes the video data preprocessing unit 103, the sensor data preprocessing unit 104, the object detection model DB 105, the object-in-image detection unit 106, the object feature amount calculation unit 107, the important object selection unit 108, the movement status recognition DNN model DB 112, and a movement status recognition unit 113. Note that the movement status recognition unit 113 may also be referred to as a recognition unit.

In the recognition phase, the movement status recognition device 100 outputs a recognition result with respect to the input video data and sensor data.

Note that in the present embodiment, the movement status recognition device 100 is provided with both a function for performing the processes of the learning phase and a function for performing the processes of the recognition phase, and it is anticipated that the configuration of FIG. 1 will be used in the learning phase while the configuration of FIG. 2 will be used in the recognition phase.

However, a device provided with the configuration of FIG. 1 and a device provided with the configuration of FIG. 2 may also be provided separately. In this case, the device provided with the configuration of FIG. 1 may also be referred to as the movement status learning device, while the device provided with the configuration of FIG. 2 may also be referred to as the movement status recognition device. Also, in this case, the model learned by the movement status recognition model learning unit 111 in the movement status learning device may be input into the movement status recognition device, and the movement status recognition unit 113 of the movement status recognition device may use the model to perform recognition.

Also, the movement status recognition DNN model construction unit 110 may not be included in the movement status recognition device 100 or the movement status learning device. In the case of not including the movement status recognition DNN model construction unit 110, a model constructed externally is input into the movement status recognition device 100 (movement status learning device).

Also, each DB in both the movement status recognition device 100 and the movement status learning device may also be provided externally to the device.

<Exemplary Hardware Configuration>

The devices described above in the present embodiment (such as the movement status recognition device 100 provided with both the function of performing the processes of the learning phase and the function of performing the processes of the recognition phase, the movement status learning device, and the movement status recognition device not provided with the function for performing the processes of the learning phase) are all achievable by causing a computer to execute a program stating the processing content described in the present embodiment, for example. Note that the “computer” may also be a virtual machine provided by a cloud service. In the case of using a virtual machine, the “hardware” described herein is virtual hardware.

The devices are achievable by using hardware resources such as a CPU and memory built into the computer to execute a program corresponding to the processes performed by the devices. The above program may be recorded onto a computer-readable recording medium (such as portable memory), saved, and distributed. Furthermore, the above program may also be provided over a network such as the Internet or by email.

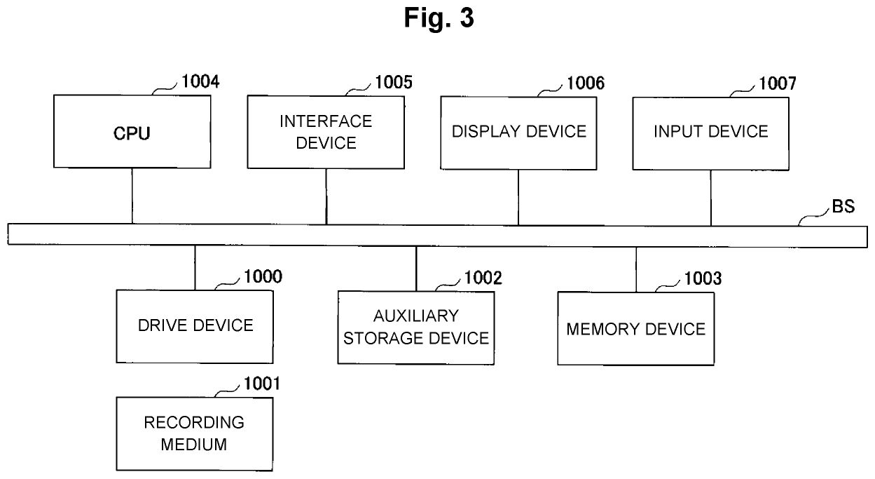

FIG. 3 is a diagram illustrating an exemplary hardware configuration of the above computer according to the present embodiment. The computer of FIG. 3 includes components such as a drive device 1000, an auxiliary storage device 1002, a memory device 1003, a CPU 1004, an interface device 1005, a display device 1006, and an input device 1007, which are interconnected by a bus B.

The program that achieves processes on the computer is provided by a recording medium 1001 such as a CD-ROM or a memory card, for example. When the recording medium 1001 is placed in the drive device 1000, the program is installed from the recording medium 1001 to the auxiliary storage device 1002 through the drive device 1000. However, the program does not necessarily have to be installed from the recording medium 1001, and may also be downloaded from another computer over a network. The auxiliary storage device 1002 stores the installed program, and also stores information such as necessary files and data.

When an instruction to launch the program is given, the memory device 1003 reads out and stores the program from the auxiliary storage device 1002. The CPU 1004 achieves functions related to the devices by following the program stored in the memory device 1003. The interface device 1005 is used as an interface for connecting to a network. The display device 1006 displays information such as a graphical user interface (GUI) provided by the program. The input device 1007 includes components such as a keyboard and mouse, one or more buttons, or a touch panel, and is used to input various operating instructions.

(Example Operations by Movement Status Recognition Device 100)

Next, example processing operations by the movement status recognition device 100 will be described. Processes by the movement status recognition device 100 are divided into a learning phase and a recognition phase. Hereinafter, each phase will be described specifically.

<Learning Phase>

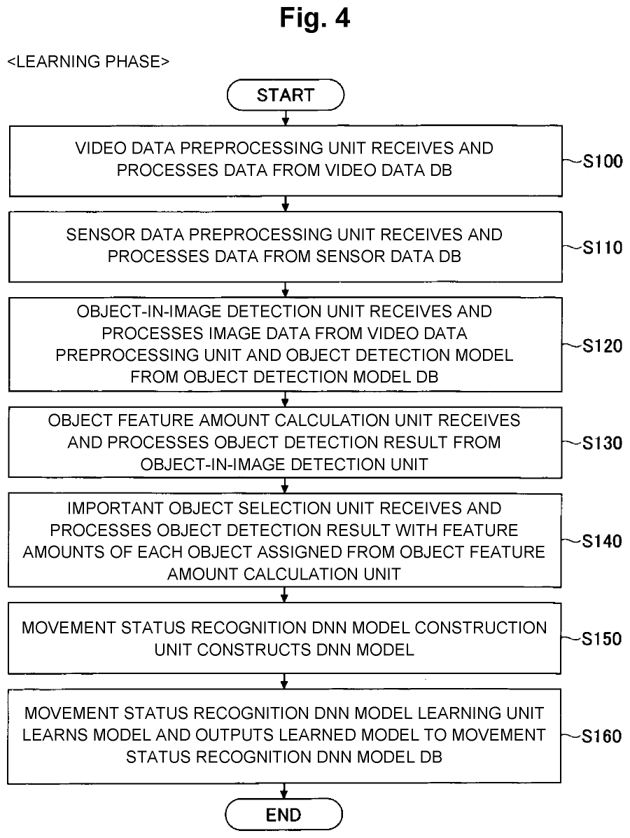

FIG. 4 is a flowchart illustrating processes by the movement status recognition device 100 in the learning phase. Hereinafter, the processes by the movement status recognition device 100 will be described following the sequence in the flowchart of FIG. 4.

Step 100:

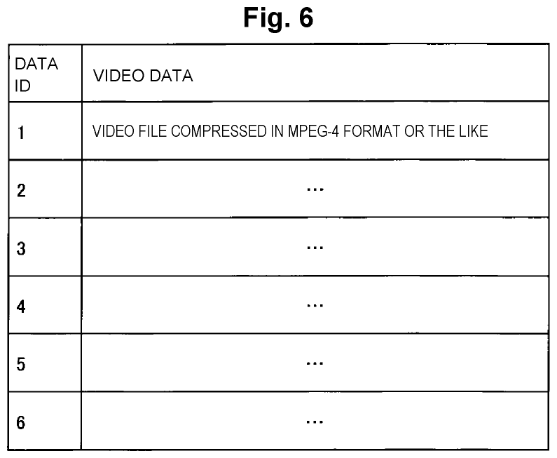

The video data preprocessing unit 103 receives and processes data from the video database DB 101. Details about the processing will be described later. An example of the data storage format of the video database DB 101 is illustrated in FIG. 6. Video data is stored as files compressed in a format such as MPEG-4, and as described earlier, each is associated with a data ID for association with sensor data.

Step 110:

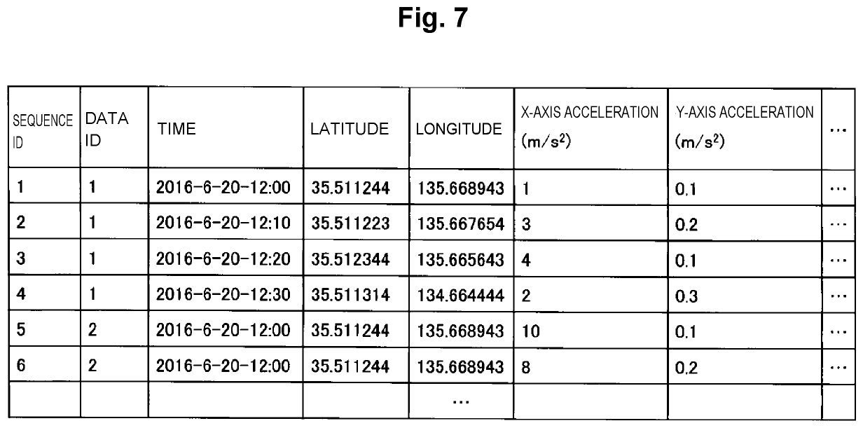

The video data preprocessing unit 103 receives and processes data from the sensor data DB 102. Details about the processing will be described later. An example of the data storage format of the sensor data DB 102 is illustrated in FIG. 7. The sensor data contains elements such as time, latitude and longitude, X-axis acceleration, and Y-axis acceleration. Each piece of sensor data has a unique sequence ID. Furthermore, as described earlier, each piece of sensor data also has a data ID for association with video data.

Step 120:

The object-in-image detection unit 106 receives image data from the video data preprocessing unit 103, receives object detection model from the object detection model DB 105, and performs processing. Details about the processing will be described later.

Step 130:

The object feature amount calculation unit 107 receives and processes object detection results from the object-in-image detection unit 106. Details about the processing will be described later.

Step 140:

The important object selection unit 108 receives and processes object detection results with feature amounts of each object assigned from the object feature amount calculation unit 107. Details about the processing will be described later.

Step 150:

The movement status recognition DNN model construction unit 110 constructs a model. Details about the processing will be described later.

Step 160:

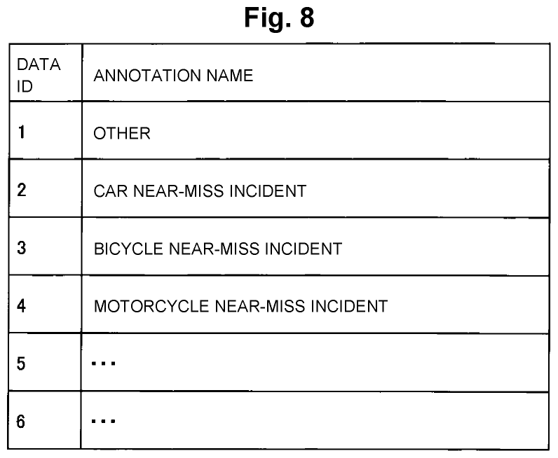

The movement status recognition DNN model learning unit 111 receives preprocessed video data from the video data preprocessing unit 103, receives preprocessed sensor data from the sensor data preprocessing unit 104, receives preprocessed object-in-image data from the important object selection unit 108, receives a DNN model from the movement status recognition DNN model construction unit 110, receives annotation data from the annotation DB 109, and uses this data to learn a model and output the learned model to the movement status recognition DNN model DB 112. An example of the storage format of the annotation DB 109 is illustrated in FIG. 8.

<Recognition Phase>

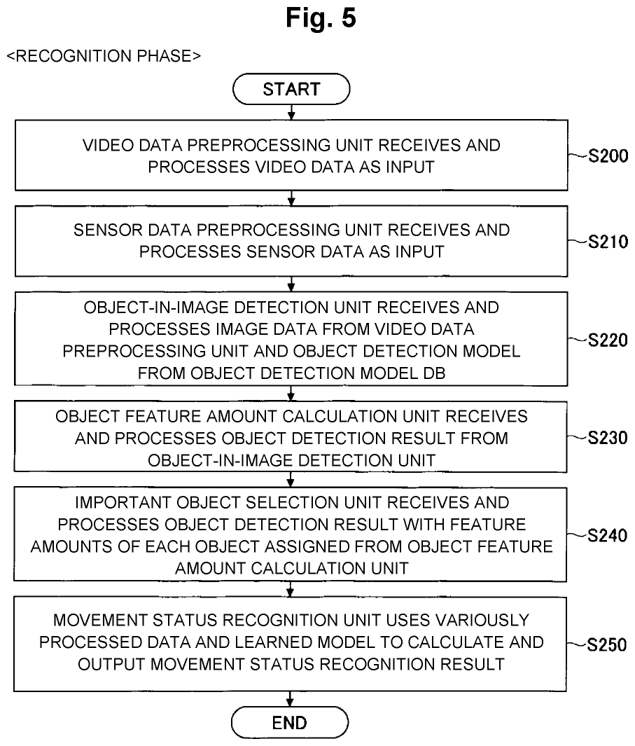

FIG. 5 is a flowchart illustrating processes by the movement status recognition device 100 in the recognition phase. Hereinafter, the processes by the movement status recognition device 100 will be described following the sequence in the flowchart of FIG. 5.

Step 200:

The video data preprocessing unit 103 receives and processes video data as input.

Step 210:

The sensor data preprocessing unit 104 receives and processes sensor data as input.

Step 220:

The object-in-image detection unit 106 receives image data from the video data preprocessing unit 103, receives object detection model from the object detection model DB 105, and performs processing.

Step 230:

The object feature amount calculation unit 107 receives and processes object detection results from the object-in-image detection unit 106.

Step 240:

The important object selection unit 108 receives and processes object detection results with feature amounts of each object assigned from the object feature amount calculation unit 107.

Step 250:

The movement status recognition unit 113 receives preprocessed video data from the video data preprocessing unit 103, receives preprocessed sensor data from the sensor data preprocessing unit 104, receives preprocessed object-in-image data from the important object selection unit 108, receives a learned model from the movement status recognition DNN model DB 112, and uses the above to calculate and output a movement status recognition result.

Hereinafter, the processes by each unit will be described in further detail.

<Video Data Preprocessing Unit 103>

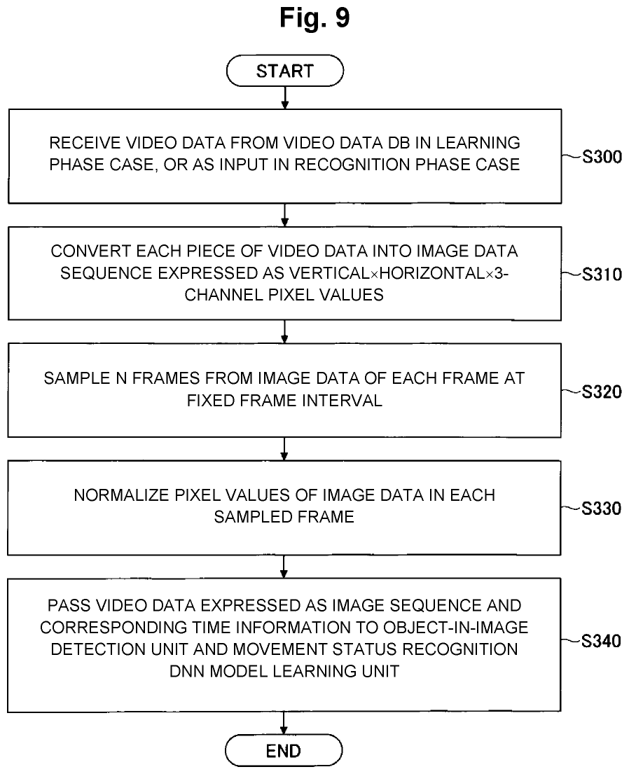

FIG. 9 is a flowchart illustrating processes by the video data preprocessing unit 103 in an embodiment of the present invention. The processes by the video data preprocessing unit 103 will be described following the flowchart of FIG. 9.

Step 300:

In the case of the learning phase, the video data preprocessing unit 103 receives video data from the video database DB 101. In the case of the recognition phase, the video data preprocessing unit 103 receives video data as input.

Step 310:

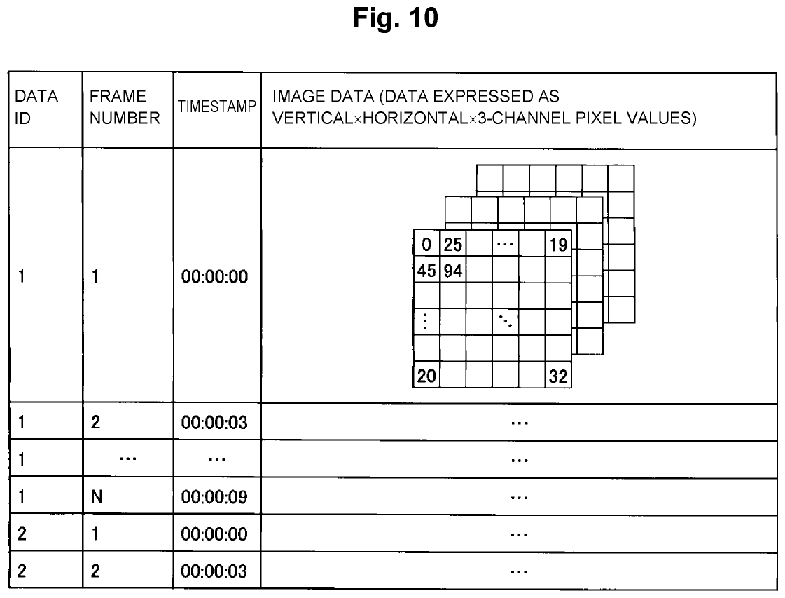

The video data preprocessing unit 103 converts each piece of video data into an image data sequence expressed by vertical×horizontal×3-channel pixel values. For example, the vertical size is determined to be 100 pixels and the horizontal size is determined to be 200 pixels. FIG. 10 illustrates an example of image data in each frame generated from the video data. Each piece of image data has a data ID associated with the original image data, a number for each frame, and timestamp information.

Step 320:

To reduce redundant data, the video data preprocessing unit 103 samples N frames from the image data of each frame at a fixed frame interval.

Step 330:

To make the image data easier for the DNN model to handle, the video data preprocessing unit 103 normalizes the pixel values of the image data in each sampled frame. For example, each pixel value is divided by the maximum value that a pixel may take so that the range of each of the pixel values is from 0 to 1.

Step 340:

The video data preprocessing unit 103 passes video data expressed as an image sequence and corresponding time information to the object-in-image detection unit 106 and the movement status recognition DNN model learning unit 111.

<Sensor Data Preprocessing Unit 104>

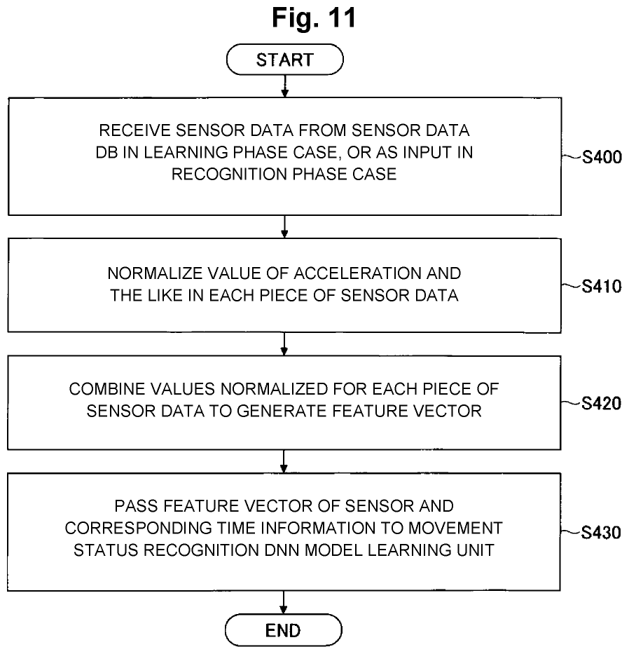

FIG. 11 is a flowchart illustrating processes by the sensor data preprocessing unit 104 in an embodiment of the present invention. The processes by the sensor data preprocessing unit 104 will be described following the sequence in the flowchart of FIG. 11.

Step 400:

In the case of the learning phase, the sensor data preprocessing unit 104 receives sensor data from the sensor data DB 102. In the case of the recognition phase, the sensor data preprocessing unit 104 receives sensor data as input.

Step 410:

To make the sensor data easier for the DNN model to handle, the sensor data preprocessing unit 104 normalizes values such as accelerations in each piece of sensor data. For example, the entire sensor data is normalized to have an average value of 0 and a standard deviation of 1.

Step 420:

The sensor data preprocessing unit 104 combines the respective normalized values in each piece of sensor data to generate a feature vector.

Step 430:

The sensor data preprocessing unit 104 passes the feature vector of the sensor and corresponding time information to the movement status recognition DNN model learning unit 111.

<Object-In-Image Detection Unit 106>

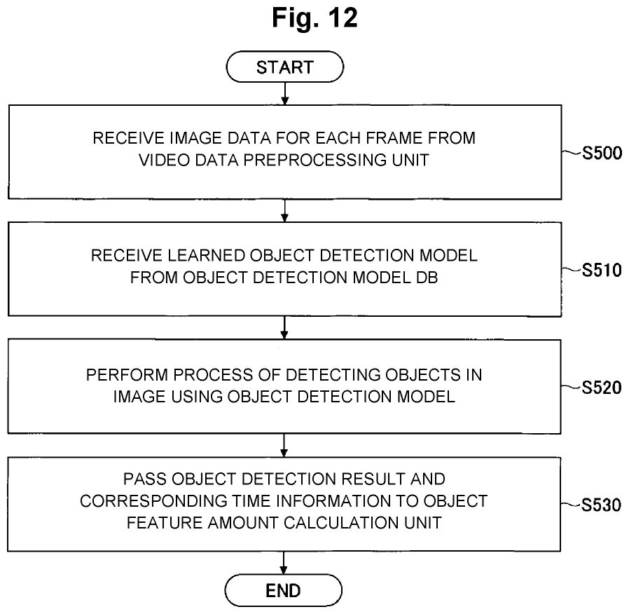

FIG. 12 is a flowchart illustrating processes by the object-in-image detection unit 106 in an embodiment of the present invention. The processes by the object-in-image detection unit 106 will be described following the sequence in the flowchart of FIG. 12.

Step 500:

The object-in-image detection unit 106 receives image data for each frame from the video data preprocessing unit 103.

Step 510:

The object-in-image detection unit 106 receives a learned object detection model (model structure and parameters) from the object detection model DB 105.

Step 520:

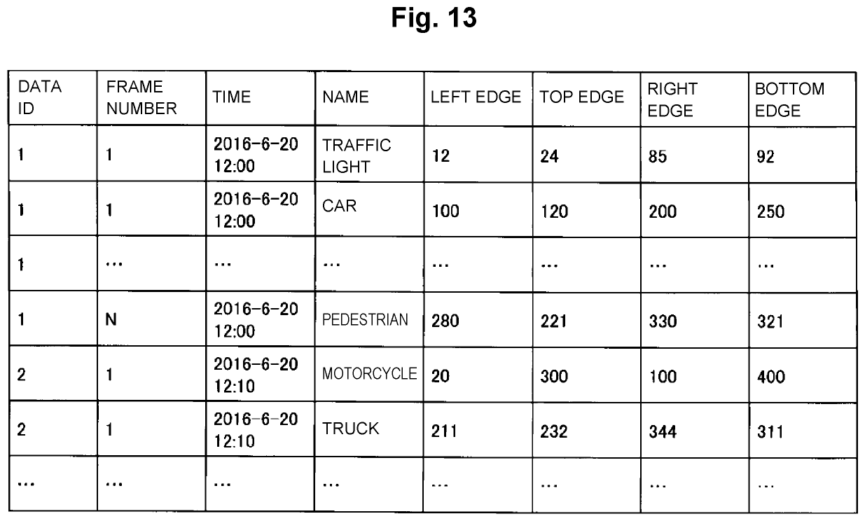

The object-in-image detection unit 106 uses the object detection model to perform a process of detecting objects in the image. An example of object detection results obtained from the image data is illustrated in FIG. 13. Each detected object has a name expressing the object and information about coordinates (left edge, top edge, right edge, bottom edge) expressing the detection bounding box.

Step 530:

The object-in-image detection unit 106 passes object detection results and corresponding time (clock time) information to the object feature amount calculation unit 107.

<Object Feature Amount Calculation Unit 107>

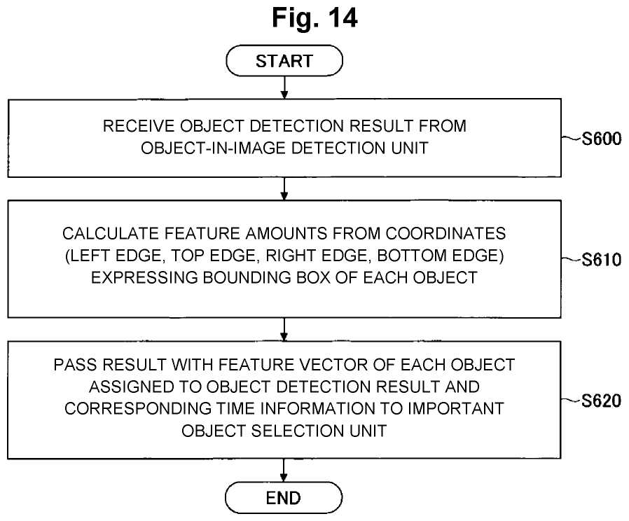

FIG. 14 is a flowchart illustrating processes by the object feature amount calculation unit 107 in an embodiment of the present invention. The processes by the object feature amount calculation unit 107 will be described following the sequence in the flowchart of FIG. 14.

Step 600:

The object feature amount calculation unit 107 receives object detection results from the object-in-image detection unit 106.

Step 610:

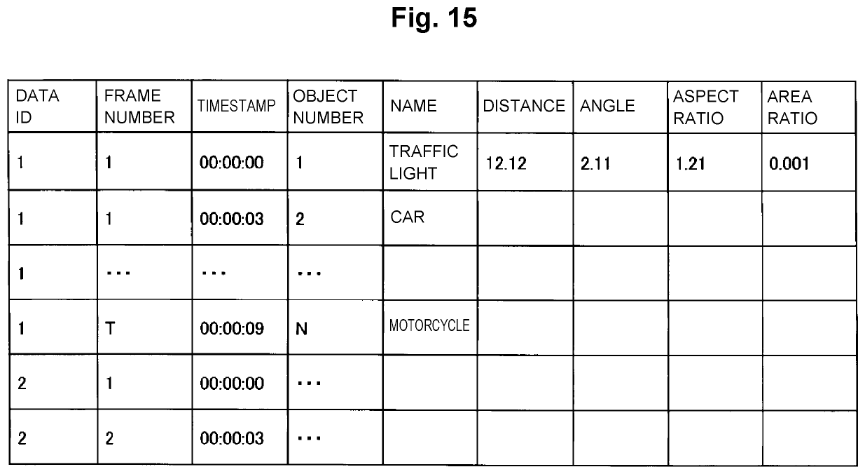

The object feature amount calculation unit 107 calculates feature amounts from the coordinates (left edge, top edge, right edge, bottom edge) expressing the bounding box of each object. An example of feature amounts calculated from the object detection results is illustrated in FIG. 15. A specific method of calculating feature amounts will be described later.

Step 620:

The object feature amount calculation unit 107 passes a result with the feature vector of each object assigned to the object detection results and corresponding time information to the important object selection unit 108.

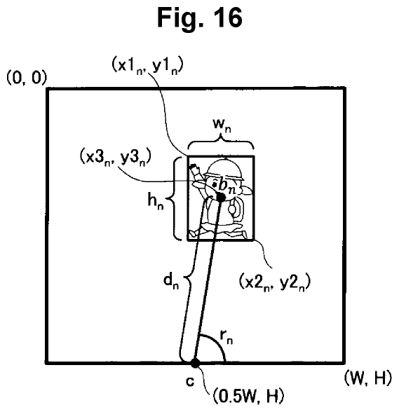

The flow of an object feature amount calculation process executed by the object feature calculation unit 107 will be described specifically below with reference to FIG. 16, which illustrates an object detection result.

Step 700:

Let H and W respectively denote the vertical and horizontal image size of the input. Here, as illustrated in FIG. 16, a coordinate space (X, Y) of an image is expressed by treating the upper-left of the image as (0, 0) and the lower-right as (W, H). Coordinates expressing the viewpoint of the recording person for example in self-centered viewpoint video recorded by eyewear or a drive recorder are given by (0.5W, H).

Step 710:

The object feature amount calculation unit 107 receives object detection results in each image frame. Here, let {o₁, o₂, . . . , o_{N}} be the set of detected objects. N is the number of objects detected from the image frame, and varies depending on the image. Let oₙ∈{1, 2, . . . , O} be an ID identifying the name of the nth∈{1, 2, . . . , N} detected object, and let x1ₙ, y1ₙ, x2ₙ, and y2ₙ respectively be the coordinates of the left edge, top edge, right edge, and bottom edge expressing the bounding box of the nth detected object. O expresses the number of types of objects. The order of objects detected at this point depends on the object detection model DB 105 and the algorithm (known technology such as YOLO) used by the object-in-image detection unit 106.

Step 720:

For each detected object n∈{1, 2, . . . , N}, the object feature amount calculation unit 107 calculates center-of-mass coordinates (x3ₙ, y3ₙ) of the bounding box according to the following expression.

$$x {3}_{n} = \frac{x {2}_{n} + x {1}_{n}}{2} , y {3}_{n} = \frac{y {2}_{n} + y {1}_{n}}{2} \qquad [ Math . 1 ]$$

Step 730:

For a detected object n∈{1, 2, . . . , N}, the object feature amount calculation unit 107 calculates a width wₙ and a height hₙ according to the following expression.

$${w}_{n} = y {2}_{n} - y {1}_{n} , {h}_{n} = x {2}_{n} - x {1}_{n} \qquad [ Math . 2 ]$$

Step 740:

For a detected object n∈{1, 2, . . . , N}, the object feature amount calculation unit 107 calculates the following four types of feature amounts. Note that calculating the following four types of feature amounts is an example.

1) The Euclidean Distance Between the Viewpoint of the Recording Person and the Object

$${d}_{n} = \sqrt{{0.5 W - x {3}_{n} )}^{2} + {( H - y {3}_{n} )}^{2}} \qquad [ Math . 3 ]$$

2) Radians Between Viewpoint of Recording Person and Object

$${r}_{n} = arctan ( \frac{H - y {3}_{n}}{{x3}_{n} - 0.5 W} ) \qquad [ Math . 4 ]$$

3) Aspect Ratio of Object Bounding Box

$${a}_{𝔫} = \frac{{w}_{n}}{{h}_{n}} \qquad [ Math . 5 ]$$

4) Area Ratio of Object Bounding Box with Respect to Entire Image

$${s}_{n} = \frac{{w}_{n} \times {h}_{n}}{W \times H} \qquad [ Math . 6 ]$$

Step 750:

The object feature amount calculation unit 107 passes a feature vector fₙ=(dₙ, rₙ, aₙ, sₙ) containing the obtained four types of elements to the important object selection unit 108.

<Important Object Selection Unit 108>

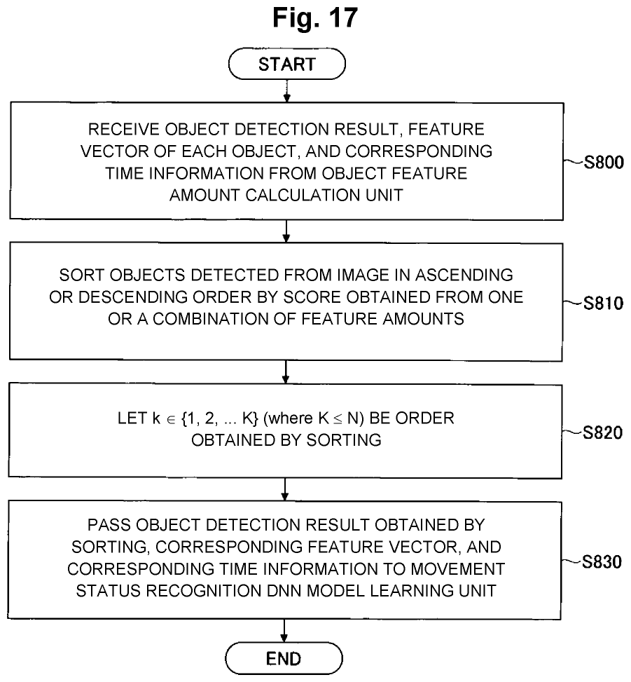

FIG. 17 is a flowchart illustrating processes by the important object selection unit 108 in an embodiment of the present invention. The processes by the important object selection unit 108 will be described following the sequence in the flowchart of FIG. 17.

Step 800:

The important object selection unit 108 receives the object detection results, the feature vector of each object, and corresponding time information from the object feature amount calculation unit 107.

Step 810:

The important object selection unit 108 sorts objects detected from the image in ascending or descending order by a score obtained from one or a combination of the four elements of the feature amount fₙ. The sorting operation here may be in order of the closest distance to the object (dₙ in ascending order) or in order of the largest objects (sₙ in descending order) for example. In addition, the sorting operation may also be in order of the farthest distance, in order of the smallest objects, in order from the right side of the image, in order from the left side of the image, or the like.

Step 820:

Let k∈{1, 2, . . . , K} (where K≤N) be the order obtained by the sorting. K may be the same value as the number of objects N in the image, but N−K objects from the tail of the result obtained by the sorting may also be removed from the object detection results.

Step 830:

The important object selection unit 108 passes the object detection results obtained by the sorting, the corresponding feature vectors, and corresponding time information to the movement status recognition DNN model learning unit 111.

<Movement Status Recognition DNN Model Construction Unit 110>

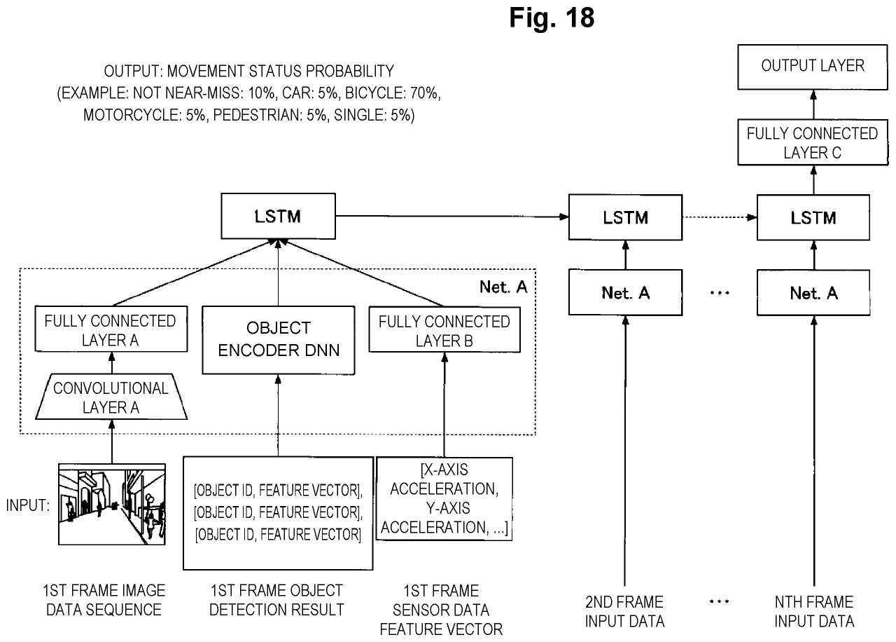

FIG. 18 is an example of the structure of a deep neural network (DNN) constructed by the movement status recognition DNN model construction unit 110 in an embodiment of the present invention. As illustrated in FIG. 18, a Net.A and LSTM are provided respectively for N frames, and the LSTM corresponding to the Nth frame is connected to a fully connected layer C and an output layer. FIG. 18 illustrates only the internal structure of the Net.A that processes the first frame, but each other Net.A also has a similar structure. Note that in the present embodiment, LSTM is used as the model for extracting features from time-series data (also referred to as sequence data), but the use of LSTM is merely an example.

As illustrated in FIG. 18, the model is a model that receives an image data sequence of each frame in video data, feature vectors of corresponding sensor data, and corresponding object detection results as input, and acquires a movement status probability as output. As illustrated in FIG. 18, the movement status probability treated as the output is an output such as not near-miss: 10%, car: 5%, bicycle: 70%, motorcycle: 5%, pedestrian: 5%, single: 5%, for example. The network contains the following units.

The first is a convolutional layer A that extracts features from the image sequence. Here, an image is convoluted with a 3×3 filter for example, and the maximum value in a specific patch is extracted (maximum pooling). The convolutional layer A may also use a known network structure and pre-trained parameters such as AlexNet (Krizhevsky, A., Sutskever, I. and Hinton, G. E.: ImageNet Classification with Deep Convolutional Neural Networks, pp. 1106-1114, 2012).

The second is a fully connected layer A that further abstracts the features obtained from the convolutional layer A. Here, a function such as a sigmoid function or an ReLu function for example is used to apply a non-linear transformation to the feature amounts of the input.

The third is an object encoder DNN that extracts features from the object detection results (object IDs) and their feature vectors. Here, a feature vector that accounts for the order relationship of the objects is acquired. Details about the processing will be described later.

The fourth is a fully connected layer B that abstracts the feature vector of the sensor data to the same level as the image features. Here, like the fully connected layer A, a non-linear transformation is applied to the input.

The fifth is long short-term memory (LSTM) that further abstracts the three abstracted features as sequence data. Specifically, the LSTM successively receives the sequence data and repeatedly applies a non-linear transformation while feeding back previously abstracted information. The LSTM may also use a known network structure with forget gates (Felix A. Gers, Nicol N. Schraudolph, and Jurgen Schmidhuber: Learning precise timing with LSTM recurrent networks. Journal of Machine Learning Research, vol. 3, pp. 115-143, 2002).

The sixth is a fully connected layer C that reduces the sequence features abstracted by the LSTM into a vector of an order equal to the number of types of movement statuses to target, and calculates a probability vector with respect to each movement status. Here, the softmax function or the like is used to apply a non-linear transformation such that the sum of all elements of the feature amounts of the input is 1.

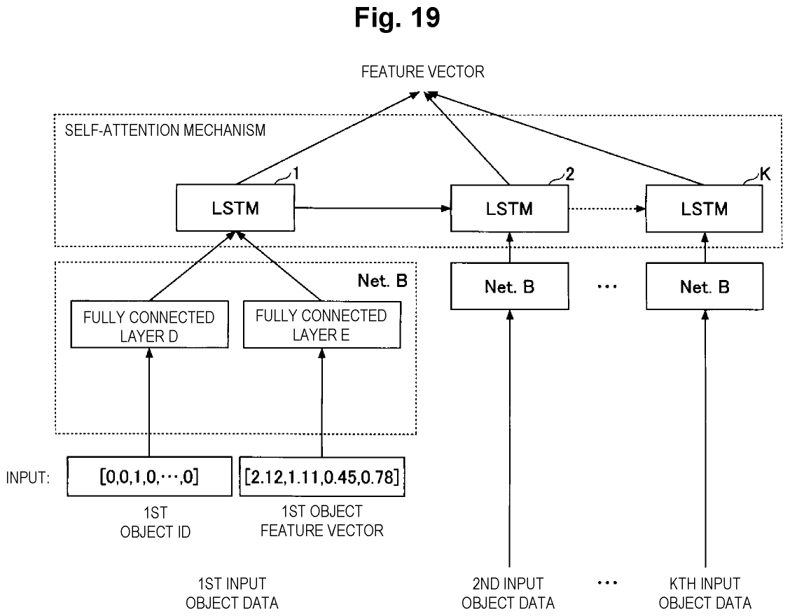

FIG. 19 is an example of the structure of the object encoder DNN that forms a portion of the movement status recognition DNN in an embodiment of the present invention. As illustrated in FIG. 19, a Net.B and LSTM are provided respectively for K sorted objects. FIG. 19 illustrates only the internal structure of the Net.B that processes the first object data, but each other Net.B also has a similar structure. The object encoder DNN receives the object detection results and their feature vectors as input, and acquires a feature vector that accounts for the order relationship of the objects as output. The network contains the following units.

The first is a fully connected layer D that identifies what kind of object has been input according to the object ID and applies a feature transformation. Here, like the fully connected layer A, a non-linear transformation is applied to the input.

The second is a fully connected layer E that applies a feature transformation accounting for the importance of the object from the feature vector of the object. Here, like the fully connected layer A, a non-linear transformation is applied to the input.

The third is LSTM that accounts for the order of the sorted objects and applies a feature transformation to the feature vectors obtained by the above two processes as sequence data. Specifically, the LSTM successively receives the sorted object sequence data and repeatedly applies a non-linear transformation while feeding back previously abstracted information. Let hₖ be the feature vector obtained from the kth object. For example, the feature vector of the first object in the order of the sorted objects is input into the LSTM(1) illustrated in FIG. 19, the feature vector of the second object is input into the LSTM(2), . . . , and the feature vector of the Kth object is input into the LSTM(K). Note that the structure of the model like the one illustrated in FIG. 19 is an example. A structure other than the model structure illustrated in FIG. 19 may also be adopted insofar as the structure gives meaning to the order relationship of the sorted objects.

The fourth is a self-attention mechanism in which the feature vector {hₖ}^{K}ₖ₌₁ of each object obtained by the LSTM is weighted and averaged according to the importance {aₖ}^{K}ₖ₌₁ of each feature vector.

The calculation of aₖ is achieved by two fully connected layers. The first fully connected layer accepts hₖ as input and outputs a context vector of any size, while the second fully connected layer accepts the context vector as input and outputs a scalar value corresponding to the importance aₖ. A non-linear transformation may also be applied to the context vector. The importance aₖ is normalized using an exponential function for example so that the value is 0 or greater. The obtained feature vector is passed to the LSTM illustrated in FIG. 18.

<Movement Status Recognition DNN Model Learning Unit 111>

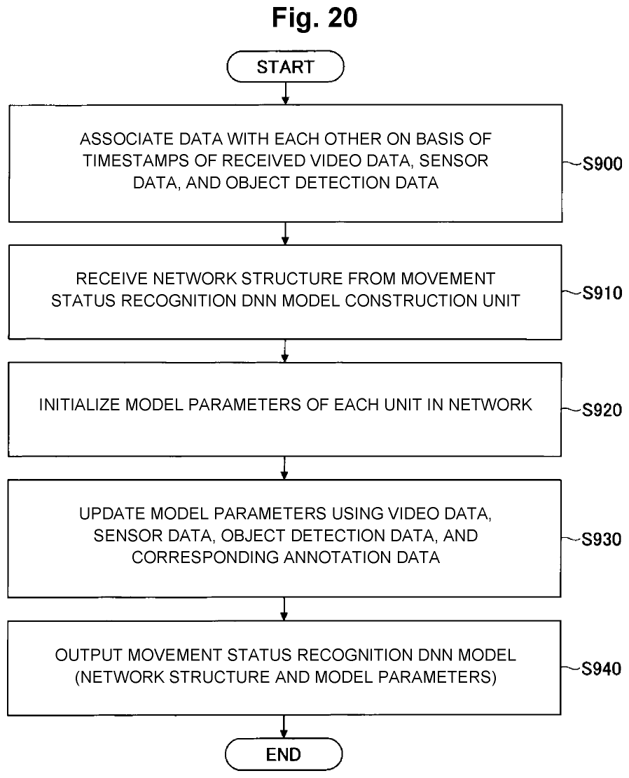

FIG. 20 is a flowchart illustrating processes by the movement status recognition DNN model learning unit 111 in an embodiment of the present invention. The processes by the movement status recognition DNN model learning unit 111 will be described following the sequence in the flowchart of FIG. 20.

Step 900:

The movement status recognition DNN model learning unit 111 associates data with each other on the basis of time information (a timestamp) for each piece of received video data, sensor data, and object detection data.

Step 910:

The movement status recognition DNN model learning unit 111 receives the network structure illustrated in FIG. 18 from the movement status recognition DNN model construction unit 110.

Step 920:

The movement status recognition DNN model learning unit 111 initializes the model parameters of each unit in the network. For example, the model parameters are initialized with random numbers from 0 to 1.

Step 930:

The movement status recognition DNN model learning unit 111 updates the model parameters using video data, sensor data, object detection data, and corresponding annotation data.

Step 940:

The movement status recognition DNN model learning unit 111 outputs a movement status recognition DNN model (a network structure and model parameters), and stores the output result in the movement status recognition DNN model DB 112.

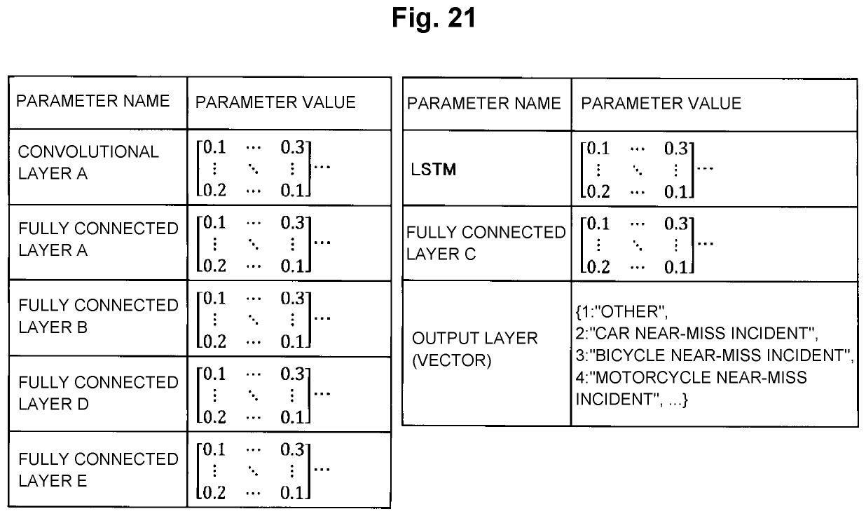

An example of the model parameters is illustrated in FIG. 21. The parameters are stored as a matrix or vector in each layer. Also, in the output layer, text of the movement status corresponding to each element number of the probability vector is stored.

<Movement Status Recognition Unit 113>

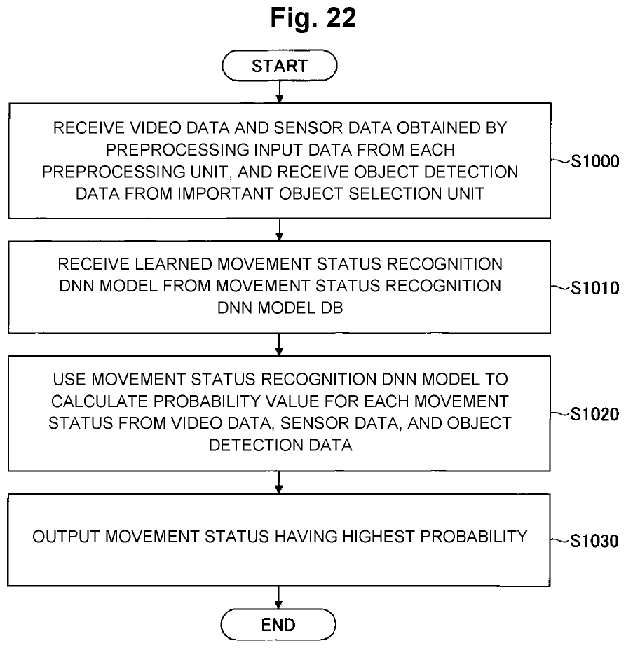

FIG. 22 is a flowchart illustrating processes by the movement status recognition unit 113 in an embodiment of the present invention. The processes by the movement status recognition unit 113 will be described following the sequence in the flowchart of FIG. 22.

Step 1000:

The movement status recognition unit 113 receives video data and sensor data obtained by preprocessing input data from each preprocessing unit, and receives object detection data from the important object selection unit 108.

Step 1010:

The movement status recognition unit 113 receives a learned movement status recognition DNN model from the movement status recognition DNN model DB 112.

Step 1020:

The movement status recognition unit 113 calculates a probability value for each movement status by inputting video data, sensor data, and object detection data into the movement status recognition DNN model.

Step 1030:

The movement status recognition unit 113 outputs the movement status having the highest probability. Note that the above probability value may be referred to as the recognition result, or the movement status that is ultimately output may be referred to as the recognition result.

### Effects of Embodiment

With the technology according to the present embodiment described above, by constructing and training a model using video data in addition to sensor data, and using the obtained model for movement status recognition, it is possible to recognize the movement status of a user that cannot be recognized in the related art.

In addition, it is possible to recognize the movement status of a user with high precision by a movement status recognition DNN model provided with a convolutional layer capable of handling image features effective for recognizing the status of a user, a fully connected layer capable of abstracting features with an appropriate degree of abstraction, and LSTM capable of abstracting sequence data efficiently.

In addition, it is possible to recognize the movement status of a user with high precision by using object detection results effective for recognizing the status of a user as input data.

In addition, by calculating feature amounts of an object from a bounding box of the object detection results, it is possible to account for properties such as the object distance, position, and size, and it is possible to recognize the movement status of a user with high precision.

By sorting the object detection results according to the feature amounts of objects, it is possible to construct a sequence data structure that accounts for the order relationship of nearby objects.

By processing the sequence data structure accounting for the order relationship as sequence information with a DNN, estimation that accounts for the importance of the objects is possible, and it is possible to recognize the movement status of a user with high precision.

### Summary of Embodiments

As described above, in the learning phase of the present embodiment, the video data preprocessing unit 103 processes data from the video database DB 101. The sensor data preprocessing unit 104 processes data from the sensor data DB. The object-in-image detection unit 106 performs a process of detecting objects in each image. The object feature amount calculation unit 107 and the important object selection unit 108 process the object detection results. The movement status recognition DNN model construction unit 110 constructs a DNN capable of handling video data, sensor data, and object detection data.

From the constructed DNN, the movement status recognition DNN model learning unit 111 uses the processed data and annotation data to learn and optimize a movement status recognition DNN model according to the error obtained from the output layer, and outputs to the movement status recognition DNN model DB 112.

Furthermore, in the prediction phase, the video data preprocessing unit 103 processes input video data. The sensor data preprocessing unit 104 processes input sensor data. The object-in-image detection unit 106 processes each frame image. The object feature amount calculation unit and the important object selection unit 108 process the object detection results. The movement status recognition unit 113 uses the learned model data in the movement status recognition DNN model DB to calculate and output a movement status recognition result from the preprocessed video data, sensor data, and object detection data.

To make the video data easier for the DNN to handle, the video data preprocessing unit 103 performs preprocessing such as sampling and normalization. To make the sensor data easier for the DNN to handle, the sensor data preprocessing unit 104 performs preprocessing such as normalization and feature vectorization.

The object-in-image detection unit 106 preprocesses the results obtained from the learned object detection model to make the results easier to the object feature amount calculation unit 107 to handle. The object feature amount calculation unit 107 calculates feature amounts accounting for the position and size of objects from the bounding box of each object detection result. The important object selection unit 108 sorts the object detection results on the basis of the feature amounts of the objects to construct sequence data accounting for the order relationship, and uses the DNN to process the sorted object detection results as sequence information.

The movement status recognition unit 113 uses the DNN model learned from the input video data, sensor data, and object detection data to calculate a probability value for each movement status. The movement status having the highest among the calculated probability values is output.

In the present embodiment, at least the following movement status learning device, movement status recognition device, model learning method, movement status recognition method, and program are provided.

### (Item 1)

A movement status learning device comprising:
a detection unit that detects a plurality of objects from image data of each frame generated from video data;
a calculation unit that calculates a feature amount of each object detected by the detection unit;
a selection unit that sorts the plurality of objects on a basis of the feature amount calculated by the calculation unit; and
a learning unit that learns a model on a basis of video data, sensor data, a feature amount of the plurality of objects in the sorted order, and annotation data.

### (Item 2)

The movement status learning device according to Item 1, wherein
the calculation unit calculates the feature amount of each object on a basis of coordinates expressing a bounding box of each object.

### (Item 3)

The movement status learning device according to Item 1 or 2, wherein
the selection unit sorts the plurality of objects in order of a shortest distance between a viewpoint of a person recording the video data and the object.

### (Item 4)

A movement status recognition device comprising:
a detection unit that detects a plurality of objects from image data of each frame generated from video data;
a calculation unit that calculates a feature amount of each object detected by the detection unit;
a selection unit that sorts the plurality of objects on a basis of the feature amount calculated by the calculation unit; and
a recognition unit that outputs a recognition result by inputting video data, sensor data, and a feature amount of the plurality of objects in the sorted order into a model.

### (Item 5)

The movement status recognition device according to claim 4, wherein
the model is a model learned by the learning unit in the movement status learning device according to any one of Items 1 to 3.

### (Item 6)

A model learning method executed by a movement status learning device, the method comprising:
a detecting step of detecting a plurality of objects from image data of each frame generated from video data;
a calculating step of calculating a feature amount of each object detected in the detecting step;
a selecting step of sorting the plurality of objects on a basis of the feature amount calculated in the calculating step; and
a learning step of learning a model on a basis of video data, sensor data, a feature amount of the plurality of objects in the sorted order, and annotation data.

### (Item 7)

A movement status recognition method executed by a movement status recognition device, the method comprising:
a detecting step of detecting a plurality of objects from image data of each frame generated from video data;
a calculating step of calculating a feature amount of each object detected in the detecting step;
a selecting step of sorting the plurality of objects on a basis of the feature amount calculated in the calculating step; and
a recognizing step of outputting a recognition result by inputting video data, sensor data, and a feature amount of the plurality of objects in the sorted order into a model.

### (Item 8)

A program causing a computer to function as each unit in the movement status learning device according to any one of Items 1 to 3.

### (Item 9)

A program causing a computer to function as each unit in the movement status recognition device according to Item 4 or 5.

The above describes the present embodiment, but the present invention is not limited to such a specific embodiment, and various alterations and modifications are possible within the scope of the gist of the present invention stated in the claims.

### REFERENCE SIGNS LIST

100 movement status recognition device
101 video database DB
102 sensor data DB
103 video data preprocessing unit
104 sensor data preprocessing unit
105 object detection model DB
106 object-in-image detection unit
107 object feature amount calculation unit
108 important object selection unit
109 annotation DB
110 movement status recognition DNN model construction unit
111 movement status recognition DNN model learning unit
112 movement status recognition DNN model DB
113 movement status recognition unit
1000 drive device
1001 recording medium
1002 auxiliary storage device
1003 memory device
1004 CPU
1005 interface device
1006 display device
1007 input device

1. A movement status learning device comprising:
a detector configured to detect a plurality of objects from image data of each frame generated from video data;
a determiner configured to determine a feature amount of each object detected by the detector;
a selector configured to sort the plurality of objects on a basis of the feature amount calculated by the determiner; and
a learner configured to learn a model on a basis of video data, sensor data, a feature amount of the plurality of objects in the sorted order, and annotation data.

2. The movement status learning device according to claim 1, wherein
the determiner determines the feature amount of each object on a basis of coordinates expressing a bounding box of each object.

3. The movement status learning device according to claim 1, wherein
the selector sorts the plurality of objects in order of a shortest distance between a viewpoint of a person recording the video data and the object.

4. A movement status recognition device comprising:
a detector configured to detect a plurality of objects from image data of each frame generated from video data;
a determiner configured to determine a feature amount of each object detected by the detector;
a selector configured to sort the plurality of objects on a basis of the feature amount calculated by the determiner; and
a recognizer configured to output a recognition result by inputting video data, sensor data, and a feature amount of the plurality of objects in the sorted order into a model.

5. (canceled)

6. A computer-implemented method for learning a model, the method comprising:
detecting, by a detector, a plurality of objects from image data of each frame generated from video data;
determining, by a determiner, a feature amount of each object detected in the detecting step;
sorting, by a selector, the plurality of objects on a basis of the feature amount calculated in the calculating step; and
learning, by a learner, the model on a basis of video data, sensor data, a feature amount of the plurality of objects in the sorted order, and annotation data.

7-8. (canceled)

9. The movement status learning device according to claim 1, wherein the model includes a deep neural network.

10. The movement status learning device according to claim 1, wherein the feature amount is based on coordinates associated with a boundary area of each object.

11. The movement status learning device according to claim 2, wherein
the selector sorts the plurality of objects in order of a shortest distance between a viewpoint of a person recording the video data and the object.

12. The movement status recognition device according to claim 4, wherein the model includes a deep neural network.

13. The movement status recognition device according to claim 4, wherein the feature amount is based on coordinates associated with a boundary area of each object.

14. The movement status recognition device according to claim 4, wherein
the sorting of the plurality of objects is based on an order of a shortest distance between a viewpoint of a person recording the video data and the object.

15. The computer-implemented method according to claim 6, wherein
the determiner determines the feature amount of each object on a basis of coordinates expressing a bounding box of each object.

16. The computer-implemented method according to claim 6, the selector sorts the plurality of objects in order of a shortest distance between a viewpoint of a person recording the video data and the object.

17. The computer-implemented method according to claim 6, wherein the model includes a deep neural network.

18. The computer-implemented method according to claim 6, wherein the feature amount is based on coordinates associated with a boundary area of each object.

19. The computer-implemented method according to claim 6, wherein
the selector sorts the plurality of objects in order of a shortest distance between a viewpoint of a person recording the video data and the object.

20. The computer-implemented method according to claim 15, wherein
the selector sorts the plurality of objects in order of a shortest distance between a viewpoint of a person recording the video data and the object.
